(19) United States
(12) Patent Application Publication
(10) Pub. No.: US 2006/0108495 A1
(43) Pub. Date: May 25, 2006

(54) Screw-in post support

(76) Inventors: Simon Walker, Delta (CA); Jenkin Suen, Richmond (CA)

Correspondence Address: Paul Smith Intellectual Property Law, 330-1508 West Broadway, Vancouver, BC, V6JIW8, CA

(21) Appl. No.: 10/541,487

(22) PCT Filed: Jan. 8, 2003
(86) PCT No.: PCT/CA03/00021

§ 371 Date: Jul. 7, 2005

(51) Int. Cl. F16M 13/00

(52) U.S. Cl. 248/522; 248/530

(57) ABSTRACT

A screw-in post support for use in supporting a post vertically above the ground. The post support has a four-sided post-receiving box mounted atop a shaft having a helical blade affixed thereto. Opposed rectangular slots are provided in two of the walls adjacent the floor of the box. The slots are dimensioned to allow the insertion of a rectangular piece of lumber in order to provide the necessary torque to screw the post support into and out of the ground. A pair of adjacent walls may be equipped with flanges that may be drawn toward one another to clamp the box around a post.

### FIELD OF THE INVENTION

The invention relates to the field of structural supports and in particular screw-in post supports.

### BACKGROUND OF THE INVENTION

When building a structure such as a fence or deck, post supports can be used to simplify the construction process. Typically these post supports take the form of an open-top metal box section connected to a spike having vertically tapered blades. The spike may be hammered into the ground and the supported element, such as a fence post or deck support post are seated snugly in the metal box section where they are secured with bolts, screws, nails or the like. Because the post support is hammered into the ground, it is often difficult to ensure a proper vertical orientation. Removal of the post support may also prove difficult in such cases.

It is also known to replace the vertically tapered blades with a helical screw blade disposed only at the ground engaging end of the spike and providing a relatively longer spike. This allows the screw to engage the ground below the frost line. This arrangement allows the supported structure to remain stable despite the heaving due to frost and the loosening of the ground that occurs through the frost depth upon thawing. In such prior art, the box portion of the post support is replaced with a U-shaped member. This facilitates the manual or mechanical screwing of the spike into the ground as the U-shaped member allows the passage therethrough (laterally) of an elongated member or of an engagement arm to allow manual or mechanical torquing of the post. The U-shaped member of the prior art is typically dimensioned to a standard size of dimensioned lumber, for example for 2×4 lumber. In the given example, a 2×4 piece of lumber may be extended trough the U-shaped member to be used to manually apply torque to screw the post support into the ground. However, as the U-shaped member only has two sides, it is sometimes difficult to achieve proper centering of the post on the member prior to securing it.

It is also known to provide a post support with an extended helical screw blade affixed to a spike, which in turn is connected to an open-top four-sided metal box section, as taught in United Kingdom Patent Application No. GB2365455. In order to allow for the application of sufficient torque the post support of GB2365455 provides a circular hole centered in the faces of opposite sides of the metal box. A bar or the like may be threaded through the circular hole to aid in insertion or removal of the post support. While this design overcomes the deficiencies noted above, it requires the use of a specially shaped bar—one designed to fit in the circular hole—thereby adding to the expense of the system and providing an additional tool that must be stored. Furthermore, application of force against the edge of the walls bordering the circular hole can cause the circular wall to bend thereby distorting the shape of the box that is intended to receive a square post.

Accordingly, a need exists for an improved post support providing ease in installation and removal, and which overcomes the deficiencies noted above. Other objects of the invention will be apparent from the description that follows.

### SUMMARY OF THE INVENTION

According to the present invention there is provided a post support for supporting a post above the ground. The support comprises a shaft having at least one helical blade thereon and a post-receiving box on one end of the shaft. The post-receiving box has a floor and four side walls oriented substantially perpendicular to the floor. Opposed first and second walls extend from the floor and opposed third and fourth walls extend generally between the first and second walls. The third and fourth walls have bottom edges that are spaced from the floor to define opposed rectangular slots in the box.

In a further aspect of the invention, the bottom sides of the slots are defined by said floor. Each slot is dimensioned to accommodate a standard sized cut of lumber.

In yet another aspect of the invention, there is also provided at least one pair opposed, parallel and spaced flanges extending outwardly from the first and third walls, said flanges being adapted to be drawn toward one another.

Other aspects of the invention will be appreciated by reference to the detailed description of the preferred embodiment and to the claims that follow.

### BRIEF DESCRIPTION OF THE DRAWINGS

These preferred embodiment of the invention will be described by reference to the drawings thereof in which:

FIG. 1 is a front elevation of a post support according to the preferred embodiment of the invention, shown inserted into the ground;

FIG. 2 is a plan view of the post support of the preferred embodiment;

FIG. 3 is a perspective view of the box portion of the post support of the preferred embodiment; and,

FIG. 4 is an opposite perspective view of the box portion of the post support of the preferred embodiment.

### DESCRIPTION OF THE PREFERRED EMBODIMENT OF THE INVENTION

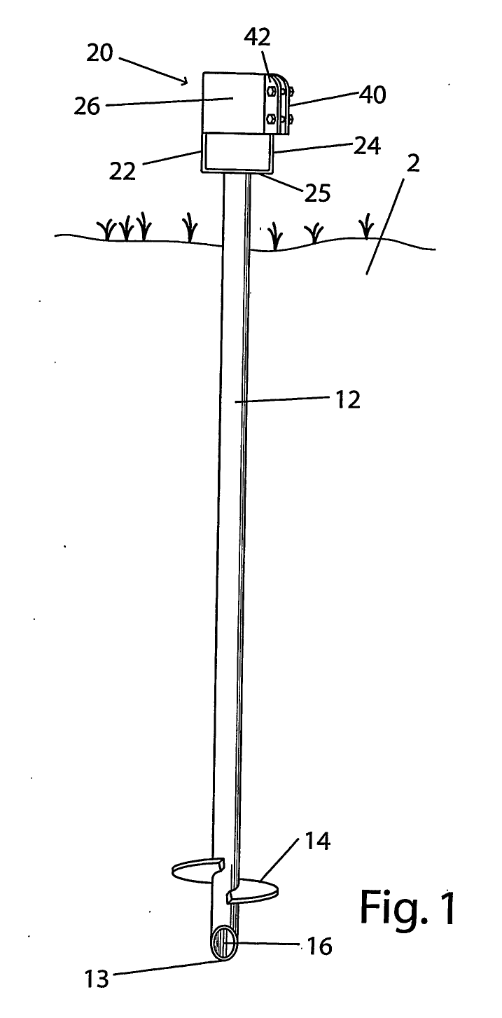

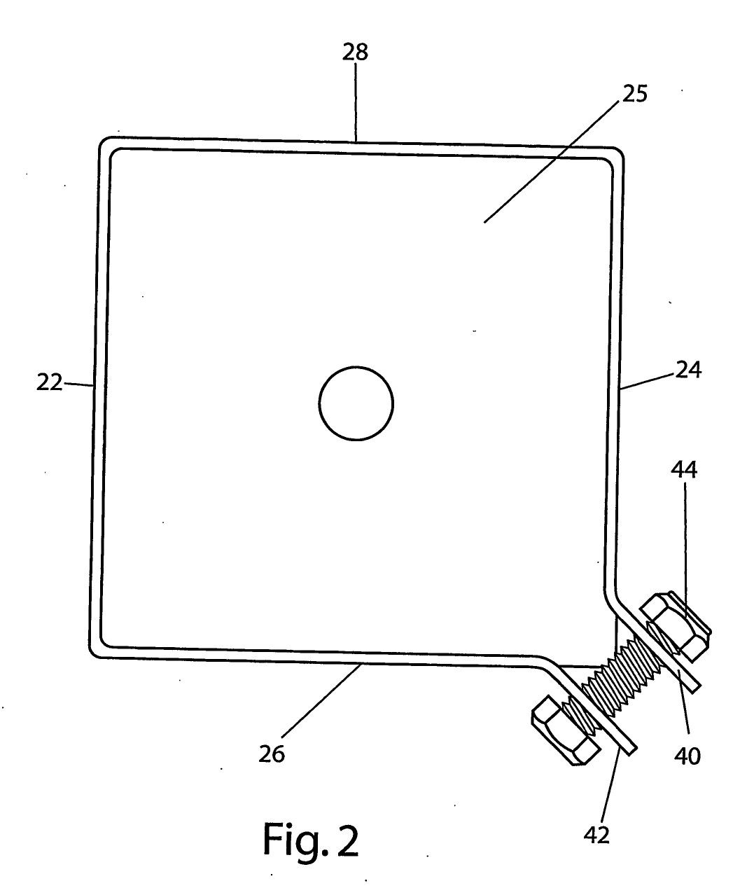

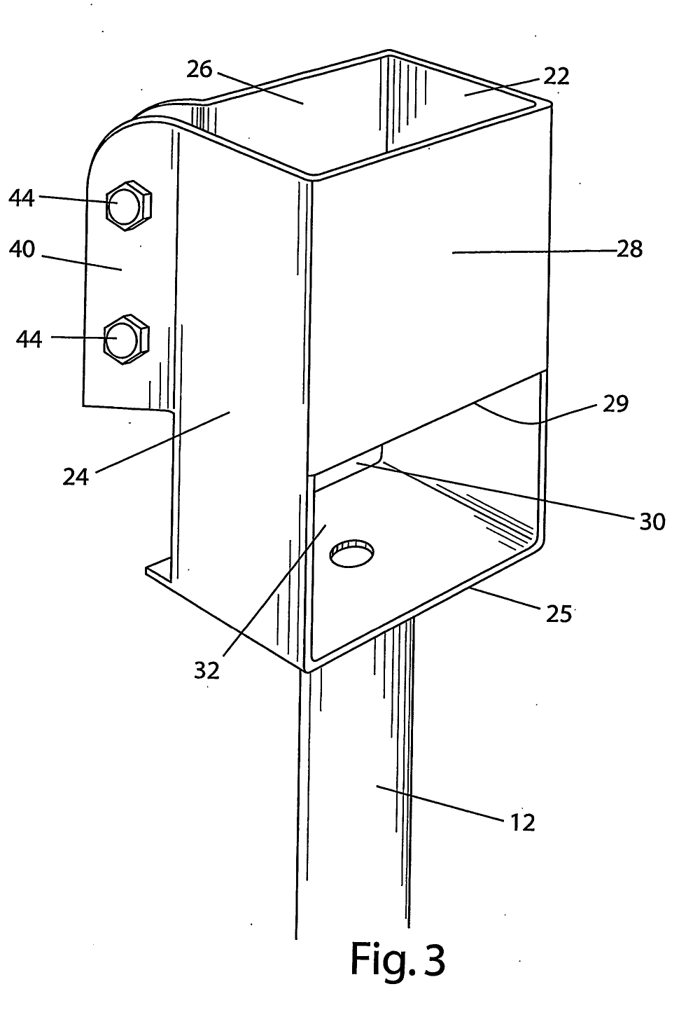

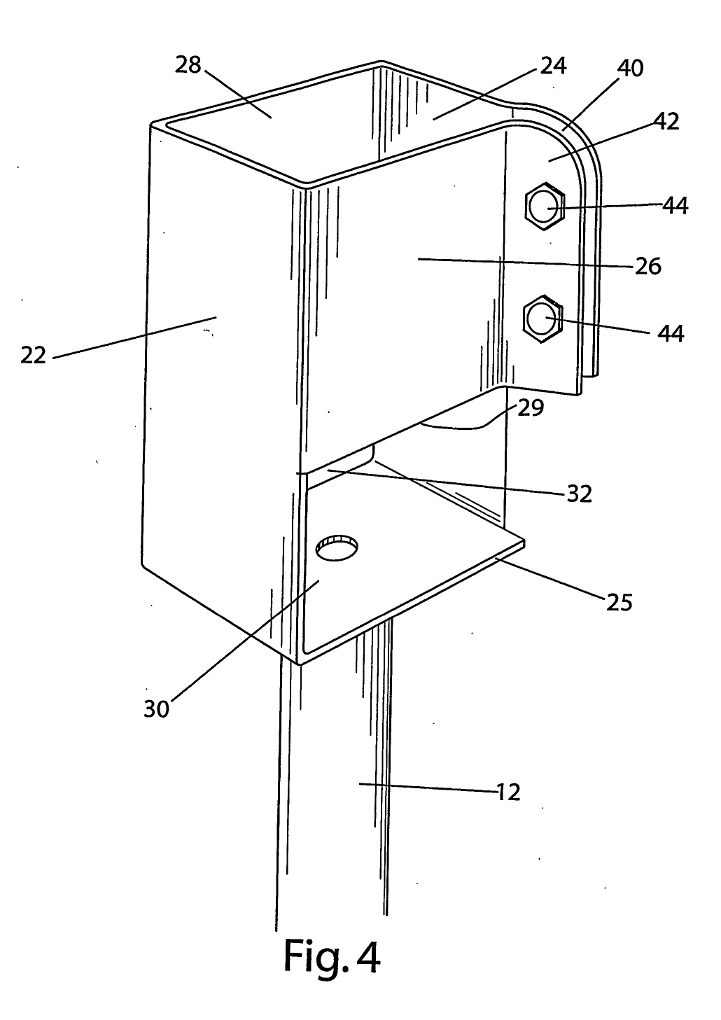

The preferred embodiment of the post support of the invention is illustrated in FIGS. 1 to 4.

A shaft 12, has a helical blade 14 affixed thereto, preferably by welding. The blade is adapted to screw into the ground and is preferably disposed only at the ground-engaging end of the shaft. The ground-engaging end of the shaft 12 tapers to a point 13.

The shaft may be hollow and point 13 may be provided with an opening 16 defined by the wall of the shaft. Thus, when the shaft is inserted into the ground, soil may enter the hollow interior through opening 16. This allows for easier insertion of the shaft into the ground, as less soil must be displaced to create space for the shaft.

A post receiving box 20 is connected to the spike 12, preferably by welding the base 25 of the box to the spike 12. Box 20 has four side walls 22, 24, 26 and 28. Opposed side walls 22, 24 extend vertically from, and substantially perpendicular to, base 25. Side walls 26 and 28 each extend substantially between side walls 22 and 24, but the bottom edges 27 and 29 of side walls 26 and 28 are spaced from the base 25 a distance sufficient to accommodate a standard width of dimensioned lumber, for example at least 1¾″ for 2×4 lumber. The spacing of the bottom edges 27 and 29 from the base 25 form rectangular slots 30, 32 through which dimensioned lumber may be inserted horizontally to torque the post support.

Preferably, the base 25 and two of the side walls of the box are formed from a single piece of metal rather than being formed separately then welded, so as to minimize the risk of failure of such weld when applying torque to the box to screw the post support into the ground.

Insertion of a piece of 2×4 lumber through slots 30 and 32 allows for application of sufficient torque to screw the post support into the ground 2. Because the post support is used in the construction of fences, decks and the like, a plentiful supply, of such lumber should be available for use in screwing the post support into the ground. After the post supports have been put in place, the lumber used to screw in the post supports may be used in construction of the intended structure, burned or otherwise disposed of. Furthermore, because the force is applied against the broad interior surfaces of walls 22 and 24 near the base 25, and because walls 22 and 24 are otherwise joined together through wall 28, the edges of side walls 22 and 24 are not likely to bend inwards or otherwise distort when torque is applied.

Walls 24 and 28 further comprise flange portions 40 and 42 respectively, extending diagonally outward from a corner of box 20, substantially parallel to each other. Bolts 44 or the like may be inserted through holes (not shown) in each of flange portions 40 and 42. After a two by four is used to screw the post support the desired distance into the ground, a post is inserted into post receiving box 20 and bolts 44 may be tightened, thereby reducing the cross sectional size of the box 20 so as to hold the post firmly in place. It will also be appreciated that as a result of this flange tightening arrangement, side wall 26 strictly speaking does not extend between side wall 22 and side wall 24 but more precisely it extends between side wall 22 and the flanged opening between side wall 26 and side wall 24.

The size of the box 20, and the post support as a whole, may be varied in order to accommodate different standard sizes of dimensioned lumber. Preferably, the spacing between walls 22 and 24 and between walls 26 and 28 is chosen to correspond to standard widths of cut lumber, for example 3 and ½ inches to accommodate 4×4 lumber in the box. If the size of the box increases, so does the size of slots 30, 32. Preferably, lumber inserted into slots 30 and 32 shares similar dimensions as the slots in order to prevent excessive forces being placed on the outer edges of side walls 22 and 24. However, even if a smaller lumber piece, for example a two by four, were used in a larger sized opening, for example an opening sized for a two by eight, the resultant forces would not alter the effectiveness of the box 20.

The use of a substantially four-sided box provides reliable and complete support for the post, while the slots 30, 32 at the base of the box allow the insertion of a torquing element without the need for specialized tools and minimizing the risk of deformation of the box due to torquing.

It will be appreciated by those skilled in the art that the preferred and alternative embodiments have been described in some detail but that certain modifications may be practiced without departing from the principles of the invention.

What is claimed is:

1. A post support for supporting a post above the ground comprising:
a shaft having at least one helical blade thereon;
a post-receiving box on one end of said shaft;
said post-receiving box having a floor and four side walls oriented substantially perpendicular to said floor;
opposed first and second ones of said walls extending from said floor;
opposed third and fourth ones of said walls extending generally between said first and second walls; and,
said third and fourth walls having bottom edges that are spaced from said floor to define opposed rectangular slots in said box.

2. The post support of claim 1 wherein a bottom side of said slots is defined by said floor.

3. The post support of claim 1 or 2 wherein each of said slots is dimensioned to accommodate a standard sized cut of lumber.

4. The post support claim 1 or 2 wherein the first and second walls are spaced from one another a distance substantially equal to one dimension of a standard size of dimensioned lumber.

5. The post support of claim 1 further comprising at least one pair of opposed, parallel and spaced flanges extending outwardly from said first and third walls, said flanges being adapted to be drawn toward one another.

6. A post support for supporting a post above the ground comprising:
a shaft having at least one helical blade thereon;
a post-receiving box on one end of said shaft;
said post-receiving box having a floor and four side walls oriented substantially perpendicular to said floor;
opposed first as and second ones of said walls extending from said floor;
opposed third and fourth ones of said walls extending generally between said first and second walls;
said third and fourth walls having bottom edges that are spaced from said floor to define opposed rectangular slots in said box, each of said slots being dimensioned to accommodate a standard sized cut of lumber; and
at least one pair opposed, parallel and spaced flanges extending outwardly from said first and third walls, said flanges being adapted to be drawn toward one another.
